(19) United States
(12) Patent Application Publication
(10) Pub. No.: US 2022/0092110 A1
(43) Pub. Date: Mar. 24, 2022

(54) TAGGING AUDIO/VISUAL CONTENT WITH REACTION CONTEXT

(71) Applicant: Hewlett-Packard Development Company, L.P., Spring, TX (US)

(72) Inventor: Mithra Vankipuram, Palo Alto, CA (US)

(73) Assignee: Hewlett-Packard Development Company, L.P., Spring, TX (US)

(21) Appl. No.: 17/423,973

(22) PCT Filed: May 10, 2019
(86) PCT No.: PCT/US2019/031751

§ 371 Date: Jul. 19, 2021

(51) Int. Cl. G06F 16/78; H04N 21/442; H04N 21/4788; H04N 21/422; H04N 21/4223; H04N 21/84; G06F 16/783

(52) U.S. Cl. CPC G06F 16/7867; H04N 21/44218; H04N 21/4788; G06F 16/7837; H04N 21/4223; H04N 21/84; H04N 21/42203

(57) ABSTRACT

An example method includes in response to disseminated audio/visual content, monitoring reactions of a plurality of users to the audio/visual content using data received from audio/visual user devices. The method further includes categorizing the reactions as corresponding to one of a plurality of reaction contexts to tag the audio/visual content with the corresponding reaction context.

### BACKGROUND

Social and business-related communications commonly employ computer network sites and server sites to convey a wide variety of audio and/or visual content in the form of images, videos, emoji's and/or emoticons, recorded sound bites, voice impressions and the like. Examples of such communications may be over various types of communication networks, for example, social networks using the Internet, for purposes including social interactions and business/advertising.

### BRIEF DESCRIPTION OF FIGURES

Various example may be more completely understood in consideration of the following detailed description in connection with the accompanying drawings, in which:

FIG. 1 illustrates an example process for tagging an audio/visual content with reaction context, in accordance with the present disclosure;

FIG. 2 illustrates an example environment for tagging an audio/visual content with reaction context, in accordance with the present disclosure;

FIG. 3 illustrates an example computing device including non-transitory computer-readable medium storing executable code, in accordance with the present disclosure; and

FIG. 4 illustrates an example graphic display of audio/visual content, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is by way of illustration, and not limitation.

### DETAILED DESCRIPTION

Aspects of the present disclosure are believed to be applicable to a variety of different types of apparatuses, systems and methods involving tagging audio/visual content with reaction context. In certain implementations, aspects of the present disclosure have been shown to be beneficial when used in the context of tagging reactions to audio/visual content, such as a photograph or sound bite, reviewed by a plurality of users. In some examples, the reactions of the plurality of users are aggregated to provide a tag count of the reaction context for a variety of purposes, such as retrieving or displaying of content based on tags and frequency of tags and automatic generation of albums of content. While not necessarily so limited, various aspects may be appreciated through the following discussion of non-limiting examples.

Accordingly, in the following description various specific details are set forth to describe specific examples presented herein. However, other examples and/or variations of these examples may be practiced without all the specific details given below. In other instances, features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or example may be combined with features of another figure or example even though the combination is not explicitly shown or explicitly described as a combination.

Audio and/or visual content, including photographs, video and audio files, may be archived by a user and used as portals to memories. A memory may refer to or include the audio and/or visual content (herein referred to as “audio/visual content”) that is tagged with various context or a plurality of aggregated tagged audio/visual content. Tagging the audio/visual content with context may be used for organizing storage of the audio/visual content, printing specific types of memories, or otherwise retrieving memories in a meaningful way, with the audio/visual content being retrieved based on the tagged context. In many instances, the sender, creator or other person associated with the audio/visual content seeks to appreciate or understand reactions to the audio/visual content. Examples in accordance with the present disclosure are directed to tagging of audio/visual content based on categorized reactions to the audio/visual content using audio/visual user devices. The audio/visual user device has a front-facing camera and/or a microphone to capture the reaction of a user to the audio/visual content as displayed or played on the audio/visual user device, and thereby capturing the user's experience of the audio/visual content. Using the camera input and/or microphone input, reaction features are extracted and used to categorize the reaction as one of a plurality of reaction contexts. The reaction features, such as facial features or speech features, are compared to a database to categorize the reaction context.

The audio/visual content may be disseminated over a communication network for accessibility by a plurality of users and for monitoring the plurality of users' reactions to the audio/visual content. For example, each of the plurality of users may access the audio/visual content over a broadband or wireless communication network such as the Internet, mobile broadband or private local-area network, using audio/visual user devices and which capture the respective users' reactions to the audio/visual content. The audio/visual user devices may communicate reaction-specific data, which may include the extracted reaction features or the categorization and tag, over the communication network such that the tags may be aggregated. As further described herein, the reaction may be categorized locally on each respective audio/visual user device and/or via a circuit associated with the communication network. In such examples, the reactions are categorized as one of the plurality of reaction contexts for tagging the audio/visual content with the corresponding reaction context and, optionally, generating a tag count associated with the corresponding reaction context for the audio/visual content using the plurality of reaction contexts.

A specific example involves a method for categorizing reactions to audio/visual content disseminated to a plurality of users over a communication network, such as a broadband and/or wireless communication network. By permitting the plurality of users to review and/or observe the audio/visual content while concurrently using the audio/visual user devices to monitor the reactions of the users, the audio/visual content may be tagged with reaction context. As an example, the reaction context may one of a plurality of predefined types of reactions, each type corresponding to or being a generalization of the data indicating the user's reaction. As a more specific example, three types of reactions may be used in this regard as: a positive reaction, a negative reaction, and a neutral reaction. Accordingly, the method includes monitoring reactions of a plurality of users to the audio/visual content using reaction-specific data received via communication circuitry from audio/visual user devices in response to audio/visual content which has been disseminated to the users, and categorizing the reactions as corresponding to one of a plurality of reaction contexts to tag the audio/visual content with the corresponding reaction context.

In another specific example, the method may further include tagging the audio/visual content by associating text or other data indicative of the corresponding reaction context with the audio/visual content. With the audio/visual content being disseminated over a communication network for accessibility by the plurality of users, a tag count associated with the corresponding reaction context for the audio/visual context may be increased based on the reactions. In this regard, a tag count includes or refers to an aggregate count of tags of reactions to a particular visual/audio content specific to or based on a plurality of users, unique users, a specific user or users, and/or reaction content. As a specific example, the tag count for each of the plurality of reaction contexts may be increased, and the method further includes graphically displaying the tag counts as being associated with the audio/visual content. Monitoring the reaction may include extracting facial features from camera input and/or speech features from microphone input and categorizing the particular reaction using the extract facial and/or speech features. The reaction context may be used to organize the audio/visual content including organization of the storage for archiving, retrieving, and/or changing a graphical display. For example, a graphical display associated with the audio/visual content may be changed based on the categorization of the one of the plurality of reaction contexts, and optionally, the changed graphical display may include data, such as an icon or text, indicative of the tag and/or tag count(s).

Other examples are directed to a non-transitory computer-readable medium storing a set of instructions executable by a processor circuit to cause a computing device to perform a variety of actions. The computing device may include an audio/visual user device. The computing device captures a reaction of a user to audio/visual content using data from an audio/visual user device, communicates reaction-specific data associated with the reaction to categorize the reaction as corresponding to one of a plurality of reaction contexts and to tag the audio/visual content, and changes a graphical display associated with the audio/visual content based on tag data indicative of a tag count of monitored reactions of a plurality of users, including the user, to the audio/visual content. The reaction-specific data may include the data from the audio/visual user device, extracted reaction features and/or the data that is indicative of the categorization and tag of the audio/visual content. The computing device may change the graphical display with respect to other audio/visual content as categorized for the one of the plurality of reaction contexts, such as prioritizing the graphical display of the audio/visual content over a plurality of other audio/visual content responsive to the tag count being above a threshold or otherwise a greater tag count than the other audio/visual content. In various specific examples, the computing device extracts the reaction features from the data from the audio/visual user device, compares the reaction features to stored features, and increases the tag count in response to the comparison.

Another example is directed to an apparatus that includes a first circuit and a second circuit. The first circuit receives reaction-specific data associated with a plurality of reactions to an audio/visual content by a plurality of users, the reaction-specific data respectively received from a plurality of audio/visual user devices. The second circuit categorizes each of the plurality of reactions as corresponding to one of a plurality of reaction contexts using the reaction-specific data, and in response to the corresponding reaction contexts, tags the audio/visual content and increases a tag count associated with the plurality of reactions contexts for the audio/visual content, as further described herein.

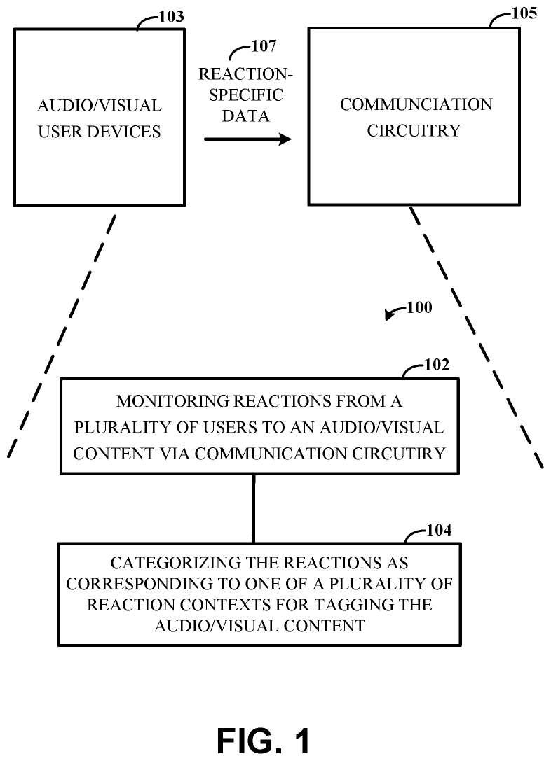

Turning now to the figures, FIG. 1 illustrates an example process for tagging an audio/visual content with reaction context, in accordance with the present disclosure. An audio/visual content includes or refers to media having sound and/or visual components. Example audio/visual content includes a photograph, a video, an audio file, an article, a live stream or presentation, text chatrooms, a trademark, etc. The audio/visual content may be accessed by a user in real time or subsequently to taking or recording the audio/visual content.

A user may view audio/visual content on a variety of different types of user devices, such as mobile phones, laptops, tablets, and other types of personal computing devices. Such user devices include audio/visual user devices 103. An audio/visual user device includes or refers to a device that has a processor circuit, a communication circuit, a display for providing visual graphics, and a speaker for providing audio. The audio/visual user device may present the audio/video content or otherwise provide access to the audio/video content via the display and/or the speaker. The audio/user device may additionally include a front-facing camera and/or microphone which is used to capture the user's reaction to the presented audio/visual content. A front-facing camera includes or refers to a camera located on a same side as the audio/visual user device as the user views data from or the same side as the display.

In various examples, the reaction may be monitored locally by the audio/visual user devices 103 and/or by circuitry associated with a communication application, such as a social network, to tag the audio/visual content with the reaction. For example, microphone input or camera input is captured responsive to or during the user experiencing the audio/visual content. From the microphone input or camera input, reaction features are extracted and used to categorize the reaction as one of a plurality of reaction contexts. The reaction features include facial features and/or speech features. Example facial features include mouth-related positions, eye-related positions, eye-brow related positions, cheek-related positions and other features such as specific facial features of the user that may be used to differentiate between different users. As some specific examples, raised cheeks with lips apart, such as in a smile, may be indicative of the user being happy. The inner and outer portions of the brows being raised, with upper lips raised and lips apart and/or stretched may be indicative of the user being scared. Inner portion of the brows being raised and the brow generally lowered, with lip corners depressed and lips apart may be indicate of the user being sad. As another example, the inner brow and outer portion of the brows being raised, with the upper lip raised and the lips apart or jaw dropped may be indicative of the user being surprised. Example speech features include amplitude of the words, particular sounds or tones, and words that may be identified using speech-to-text recognition computer-readable instructions.

The extracted reaction features may be compared to a database of features. The database may include generic features and identification of the features as being tied to a particular reaction context or specific features of other users that have already reacted to the particular audio/visual content and/or to other audio/visual content. Based on the match, the reaction is categorized as corresponding to the particular reaction context and the audio/visual content is tagged with the particular reaction context. The reaction tags may be used to archive the audio/visual content, control display or other types of retrieval of the audio/visual content, and/or to automatically generate albums of audio/visual content. As further described herein, the tag of the particular audio/visual content may be counted and used to increase a tag count for a particular reaction context, such as a positive reaction and/or counts of views by different users or a particular user. A tag count may indicative of a number of views by different users or the particular user and/or that are associated with the particular reaction context. In such examples, the particular audio/visual content may have a plurality of tag counts that are associated with different users and/or different reaction contexts. The reaction context and/or tag counts may be used to more efficiently and/or effectively store and retrieve audio/visual content. For example, the reaction context may be retrieved for display based on the reaction context and/or tag counts, allowing for reduced power consumption and reduced use of processing resources by the audio/visual user devices 103 and/or circuitry associated with the communication application.

The particular method 100 illustrated by FIG. 1 includes, at 102, monitoring reactions of a plurality of users to the audio/visual content using reaction-specific data 107 received via communication circuitry 105 from a plurality of audio/visual user devices 103. In specific examples, the reactions are monitored over a communication network that may include or be associated with a social network or other type of communication application accessible via the communication network and that provides access to audio/visual content. For example, the social network or other type of communication application may be used to disseminate the audio/visual content to a plurality of different user and in response to the dissemination, the reactions of the plurality of users are monitored. Examples of other types of communication applications include telecommunications applications that provide video chat, voice calls, instant messaging services, or otherwise allow for sharing of audio/visual media content. The communication circuitry 105, in specific examples, includes a communication circuit of each of the plurality of audio/visual user devices 103, and which allow for communication of reaction-specific data between the audio/visual user devices 103. As a specific example, the plurality of audio/visual user devices 103 wirelessly communicate with one another, such as via the Internet, a private local network, and/or near-field communication (NFC), among other types of communications. In other examples and/or in addition, the communication circuitry 105 includes a communication circuit located on a circuit associated with the communication application, such as a social network as further described herein. In various examples, the communication of the reaction-specific data 107 may be wireless and/or wired.

Monitoring the reactions may include receiving the reaction-specific data 107 associated with the reactions from the plurality of audio/visual user devices 103. In specific examples, the reaction-specific data 107 includes the reaction features or the camera and/or microphone inputs. In other examples, the reaction-specific data 107 includes data indicative of the categorization of the reaction context and, optionally, data indicative of the tag, with the audio/visual audio devices locally performing the categorization. In either such examples, at 104, the reactions are categorized as corresponding to one of a plurality of reaction contexts to tag the audio/visual context, which is performed locally on the audio/visual user devices 103 or remotely by circuitry associated with the communication application, as described above. The method may further include tagging audio/visual content by associating text indicative of the corresponding reaction context with the audio/visual content, which similarly may be performed locally by the audio/visual user device 103 or remotely. When the tagging occurs locally, the reaction-specific data 107 communicated by an audio/visual user device includes data that identifies the tag and the associated reaction context for the audio/visual content. In specific examples, tagging the audio/visual content may include or result in graphically displaying data, such as the text and/or graphical icon that is indicative of the tag, a plurality of tags, and/or tag count.

The plurality of reaction contexts may include a positive reaction, a negative reaction, and a neutral reaction. In specific examples, each of the positive, the negative, and the neutral reactions may include sub-categories. In other examples and/or in addition, the plurality of reaction context includes emotions, with or without categorization of the reactions being positive, negative or neutral. For example, the reaction contexts may include different emotions, such as happy, sad, angry, confused, bored, surprised, frustrated, scared, embarrassed, curious, excited, etc. Each of the emotions may be categorized as positive, negative or neutral. In other examples, such as a business application, the user of the tags may be interested in the broad positive, negative, and neutral reaction categorizations.

As a specific example, the audio/visual context is disseminated on a social network. The social network may be used to disseminate a plurality of audio/visual content, which may be provided by the user or a plurality of users. In such an example, the plurality of reaction contexts may include the above-described emotions. The dissemination may include graphically displaying the plurality of audio/visual content as being accessible on the social network. In various specific examples, the graphical display of the plurality of audio/visual content is changed based on the categorization of the one of the plurality of reaction contexts for the particular audio/visual content. The change may include a revision of an order of the plurality of audio/visual content. For example, audio/visual content with positive reactions, such as happy, curious and excited emotions, may be displayed together and/or prioritized over other audio/visual content with negative or neutral reactions, such as sad, angry, confused, bored, frustrated, or embarrassed emotions. Additionally, the tag, tag counts, and/or data indicative of the tagged reaction context or tag counts, may be graphically displayed with the particular audio/visual content.

In a number of related and specific examples, the changed display may be based on a tag count. For example, a tag count for the one reaction context may be increased based on the categorization. In specific examples, a tag count for each of the plurality of reaction contexts may be increased.

As another specific example, the audio/media content may be monitored for business purposes, such as marketing feedback on a product or advertisement or a business proposal plan that is viewed by a plurality of users. In such examples, the business entity may be interested in tag counts for each of the positive, negative, and neutral reactions. The tag counts may be graphically displayed as being associated with the audio/visual content. For example, the business entity may view the tag counts and use such information for revising their advertisement or business proposal. However, examples are not so limited and in various examples for business purposes, the business may be interested in additional categorization. As an example, a communication network may be used to provide health care services, such as nurses providing information to patients. The health care professional may use a video chat application to provide feedback or other information to a patient, and the reaction context of the patient or other person associated with the patient may be captured and tagged to the video chat. The reaction context may be used to revise the care and/or provide better care to the patient.

A variety of different types of tag counts may be used. As an example, a tag count may be associated with reactions of unique users, reactions of a particular user, such as the user of the particular audio/visual user device or a subject of the particular audio/visual content, and/or as related to or associated with a particular reaction context. The change in graphic display, in specific examples, may be responsive to the tag count being above a threshold. The audio/visual content, over time, is augmented with a plurality of reaction contexts and respectively associated with tag counts. The tag counts may be used to retrieve and/or display the audio/visual content, such as displaying the most frequently viewed audio/visual content or displaying the most frequently tagged reaction context with the respective audio/visual content.

In a specific example, the tag count is associated with unique users. A unique user includes or refers to a user that is reacting to the audio/visual content for the first time or that their reaction has otherwise not previously been captured. In such examples, the tag count does not include repeat reactions for a particular user. The reaction contexts that are associated with unique users of the plurality of users are identified based on the reaction-specific data communicated by the plurality of audio/visual user devices and used to increase the tag count. For example, the reaction features, such as facial features, are compared to the database of features to identify if the particular user has viewed the particular audio/visual content and/or if their reaction to the particular audio/visual content has previously been captured. If yes, the captured reaction is ignored. If not, the reaction is used to tag the audio/visual content by increasing the tag count of the particular categorized reaction context. The tag count may be used to identify respective audio/visual content that are most viewed by unique users and/or to prioritize display of audio/visual content based on the tag count and a particular reaction context, such as positive reactions getting a higher priority over negative and neutral reactions.

The audio/visual content that is shared with and reacted to by a threshold number unique users may be prioritized for retrieval and/or display. Additionally, the plurality of audio/visual content may be ordered by the tag count(s) and/or respective reaction context for graphical display and/or printing of an album, such as a photo album displayed on the user's mobile phone and/or that may be physically printed. The user may not have to scroll through all of their audio/visual content to show a particular audio/visual content to another user.

However, examples are not limited to identifying unique users and the above-described tag count may be applied to any count, such as a count that may include repeat reactions of the same user. Such examples may include number of views by a plurality of different users. Other example tag counts may include number of view by a particular user, such as the user of the particular visual/audio user device and/or by a subject of the audio/visual content.

As a specific example, a tag count may be indicative of the number of times the user, themself, accesses the audio/visual content and the respective reaction context for each access. This may be referred to as a tag count indicative of a reaction context and frequency that an audio/visual file has been accessed by the content creator. The extracted reaction features may be compared to the database of features to identify the same user is accessing the particular audio/visual content, and in response, the tag count is increased.

As another specific example, a tag count may be indicative of a number of times a user that is a subject of the visual/audio content accesses the same. Similarly to that described above, reaction features of a user accessing the audio/video content is compared to a database of reaction features, such as facial features of subjects in the audio/video content. In response to a match, a tag count indicative of a frequency for subject users is incremented and a reaction context tag, if identified, is applied to the audio/visual content.

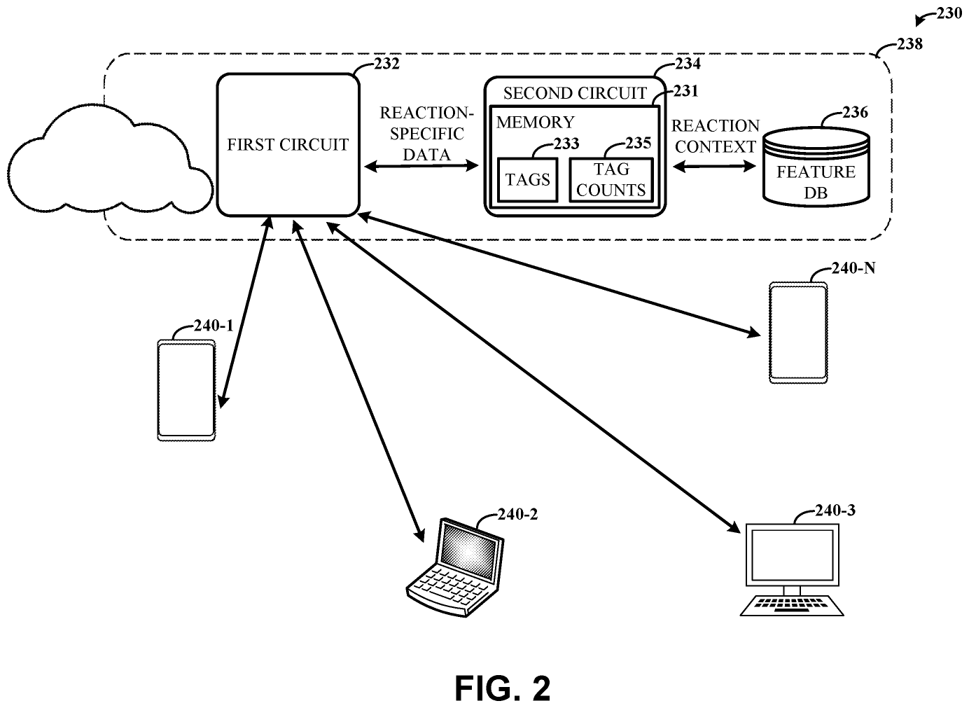

FIG. 2 illustrates an example environment for tagging an audio/visual content with reaction context, in accordance with the present disclosure. The environment 230 may include an apparatus including a first circuit 232 and a second circuit 234, as well as a plurality of audio/visual user devices 240-1, 240-2, 240-3, 240-N, herein generally referred to as “the plurality of audio/visual user devices 240” for ease of reference.

The first circuit 232 and second circuit 234, as well as the database of features 236, may be part of a trusted cloud system 238 and/or other type of communication network in various examples. For example, the first circuit 232 and second circuit 234 may include or be associated with a server used to provide a communication application that disseminates audio/visual content. Each of the first circuit 232 and second circuit 234 include a processor circuit to execute computer-readable instructions and a communication circuit to communicate data over a communication network. In some examples, the first and second circuits 232, 234 are integrated together in a computer system, such as a common computer, to communicate with the plurality of audio/visual user devices 240. In other related examples, the first circuit 232 is integrated in a computer system to communicate with the plurality of audio/visual user devices 240, and is separate from the second circuit 234. Similarly, each of the plurality of audio/visual user devices 240 have a communication circuit and a processor circuit to execute computer-readable instructions.

The first circuit 232 receives reaction-specific data associated with a plurality of reactions to an audio/visual content by a plurality of users. The reaction-specific data is respectively received from the plurality of audio/visual user devices 240 and may include camera and/or microphone input, identified categorization of a reaction content, and/or other data indicative of a tag of the audio/visual content with a reaction content.

The second circuit 234 is in communication with the first circuit 232 to categorize each of the plurality of reactions as corresponding to one of a plurality of reaction contexts using the reaction-specific data. In various examples, the second circuit 234 determines the categorization by comparing the reaction-specific data to the database of features 236. For example, the second circuit 234 may extract reaction features from the reaction-specific data and compare the reaction features to the database of features 236 for the categorization. In other examples, the reaction-specific data includes the reaction features and the second circuit 234 compares the same to the database of features 236 or the reaction-specific data includes the categorization of the reaction context and the second circuit 234 categorizes the same by identifying the reaction context. As such, in accordance with various examples, the determination of the categorization may be performed locally on the audio/visual user devices 240 or by the second circuit 234. The database of features 236 may be stored on memory internal to the second circuit 234 or external memory that is accessible by the second circuit 234.

The second circuit 234, in response to the corresponding reaction contexts, tags the audio/visual content and increases a tag count associated with the plurality of reaction contexts for the audio/visual content. As shown, the second circuit 234 may include memory 231 to store the tags 233 and the tag counts 235. When the categorization and tagging is performed locally on each of the audio/visual user devices 240, the second circuit 234 may aggregate the tags from the plurality of audio/visual user devices 240 as tag data and communicate the tag data to the plurality of audio/visual user devices 240. The tag data, as used herein, is indicative of a tag count of monitored reactions of the plurality of users to the audio/visual content. The plurality of audio/visual user devices 240, using the tag data, are updated on the aggregate counts, such as the tag count(s).

The second circuit 234 may identify the tag counts based on unique users, particular users, and/or respective reaction context. As an example, the second circuit 234 identifies reaction contexts that are associated with unique users of the plurality of users based on the reaction-specific data from the plurality of audio/visual user devices 240 and increases a respective tag count using the reaction context associated with the unique users. The second circuit 234 identifies the unique users, for example, by comparing extracted facial features to the database of features 236 to identify if a reaction to the audio/visual content has been captured for the particular user previously. In response to a match, the user is not a unique user and the reaction context is ignored for the tag count. In response to no match, the user is a unique user and the tag count is increased. As described above, tag counts are not limited to unique users and the second circuit 234 may increase a tag count based on identification of a particular user or users and/or based on a particular reaction context.

In more specific and related examples, the second circuit 234 may identify that one of the plurality of reactions is a disparagement reaction. As used herein, a disparagement reaction includes or refers to a malicious response by a user, such as a response for sabotaging the accuracy of the tag counts or tags. In response, the second circuit 234 may disregard the respective reaction context associated with the reaction for the tag count. As a specific example, a particular user may be identified as providing above a threshold number of responses, suggesting that the user is malicious. As another example, the user may be identified as being associated with a competitor, and thus, may be providing malicious responses. Other examples may include exaggerated or other specific reaction features that are identified as likely indicating untruthfulness.

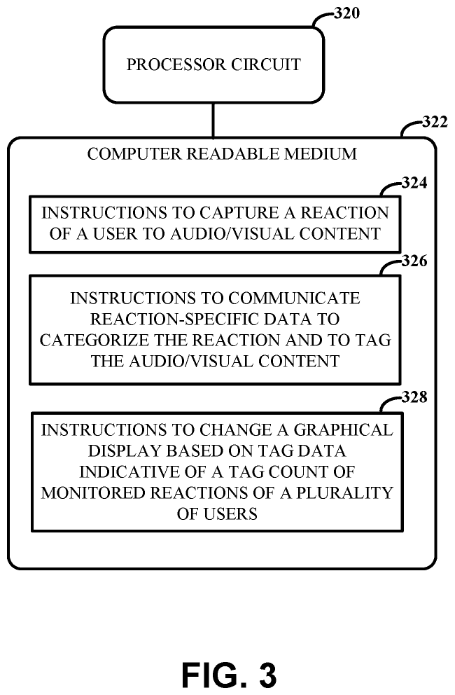

FIG. 3 illustrates an example computing device including non-transitory computer-readable medium storing executable code, in accordance with the present disclosure. The computing device, in accordance with examples herein, includes an audio/visual user device such as the device 240-1 illustrated by FIG. 2.

The computing device has a processor circuit 320 and computer readable medium 322 storing a set of instructions 324, 326, 328. The computer readable medium 322 may, for example, include read-only memory (ROM), random-access memory (RAM), electrically erasable programmable read-only memory (EEPROM), Flash memory, a solid state drive, and/or discrete data register sets. At 324, the computing device may capture a reaction of a user to audio/visual content using data from an audio/visual user device. The data may include input from a front-facing camera and/or a microphone of the audio/visual user device. At 326, the computing device communicates reaction-specific data associated with the reaction to categorize the reaction as corresponding to one of a plurality of reaction contexts and to tag the audio/visual context. The reaction-specific data, as previously described, may include the input from the front-facing camera and/or the microphone, extracted reaction features and/or indication of the categorization of the reaction context and/or tag of the audio/visual content. In some examples, the computing device extracts the reaction features using the data from the audio/visual device, such as the input from the front-facing camera and/or the microphone. The computing device may further compare the extracted reaction features to stored features, such as stored features on a database of features, and based on the comparison, categorizes the reaction as one of a plurality of reaction contexts. The computing device may increase a tag count in response to the comparison, such as tag counts that are indicative of the views by the user, views by a subject of the content, and/or most shared. The reaction-specific data may include the categorization, and optionally in addition to, the extracted features, in some examples, which is communicated to external circuitry for aggregating tags from a plurality of audio/visual user devices and generating tag counts.

At 328, the computing device changes a graphical display associated with the audio/visual content based on tag data. The tag data is indicative of tag counts of the monitored reactions of a plurality of users to the audio/visual content. The tag data, as well as the reaction-specific data, may be communicated over a communication network by circuitry. The circuitry, such as the first circuit 232 and second circuit 234 illustrated with FIG. 2, may be associated or used to provide services associated with a social network or other type of communication application.

In various specific examples, the processor circuit 320 may carry out additional or more specific operations stored on the computer readable medium 322. For example, the instructions are executable to change the graphical display with respect to other audio/visual content based on the categorization for the one of the plurality of reaction contexts. As described above, the graphical display change may include a prioritization of particular audio/visual content based on the categorization and/or tag counts. A user may program the prioritization and revise the programmed prioritization. In a related and specific examples, audio/visual content is prioritized for graphical display over a plurality of other audio/visual content responsive to the tag count being above a threshold. Prioritizing a retrieval or display of the audio/visual content may include changing an order that the audio/visual contents are retrieved or displayed based on the prioritization, with higher tag counts for a particular reaction context or type of users, such as unique users, being prioritized over respectively lower tag counts. In other examples, the prioritization may include aggregating the respective audio/visual content having threshold tag counts and/or the top threshold tag counts into an album, such a photo album or virtual album of audio/visual content.

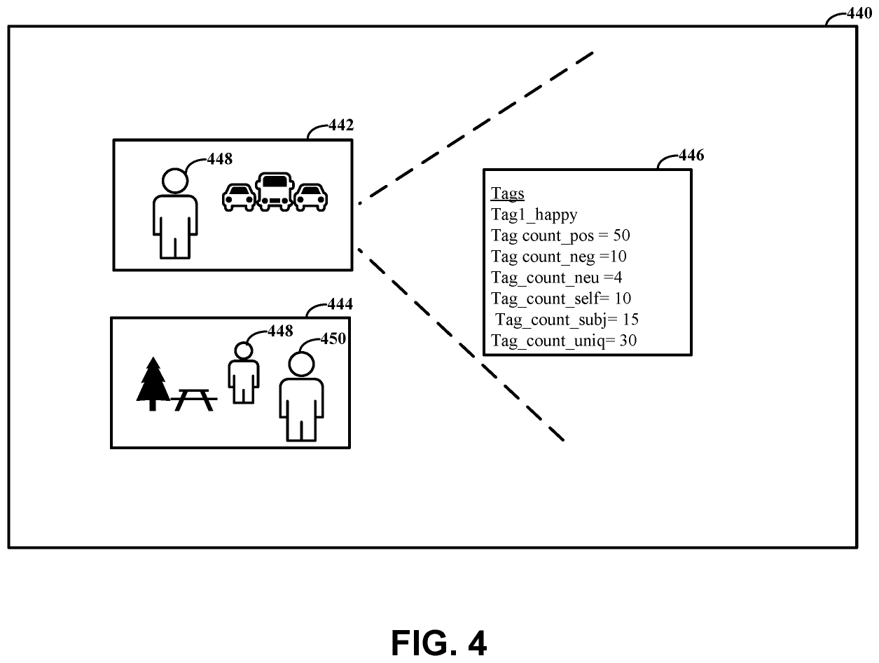

FIG. 4 illustrates an example graphic display of audio/visual content, in accordance with the present disclosure. The graphic display 440 includes visual display of two audio/visual contents which may be prioritized over other audio/visual content based on respective tags of reaction context and tag counts.

More specifically, the two audio/visual contents include photographs 442, 444, however examples are not so limited and the audio/visual content may further or alternatively include videos, audio files, and other types of audio/visual content. As shown, the photographs 442, 444 include subject users 448, 450, with a first user 448 being in both of the photographs 442, 444. The identification of the first and second users 448, 450 may be identified based on facial features, such as facial features stored in a database. Additional or fewer photographs or icons of other audio/visual content may be included in the graphic display 440, in a number of examples.

FIG. 4 additionally illustrates example tags and tag counts 446 for the second photograph 444. The tags and tag counts 446, in various examples, are not limited to the specifically illustrated tags and tag counts 446 and may include more or less counts. Example tag counts 446 include tag 1_happy which is indicative of a particular tag of a happy reaction, such as the most recent tag, tag_count_pos which is indicative of the tag count or aggregate number of positive reactions, tag_count_neg which is indicative of the tag count or aggregate number of negative reactions, and tag_count_neu which is indicative of the tag count or aggregate number of neutral reactions. Other tag and tag counts 446 examples include tag_count_self which is indicative of the tag count of reactions of the user of the audio/visual user device, tag_count_subj which is indicative of the tag count of the reactions of a subject of the audio/visual content, such as the first user 448 for the first photograph 442 and the first and second users 448, 450 for the second photograph 444, and the tag_count_uniq is indicative of a tag count of the reactions of unique users. The specific counts of the second photograph 444 illustrated by FIG. 4 may include, although examples are not so limited:

tag 1_happy of 1

tag_count_pos of 50

tag_count_neg of 10

tag_count_neu of 4

tag_count_self of 10

tag_count_subj of 15

tag_count_uniq of 30

In a number of examples, the graphic display 440 is changed based on the tags and tag counts of a plurality of audio/visual contents. Different audio/visual content may be prioritized for retrieval and/or display based on the tags and/or tag counts. As an example, audio/media content is prioritized in response to a tag count being above a threshold. Using the first photograph 442 and second photograph 444 as an example, the photographs 442, 444 are prioritized in response to the tag_count_pos being above a threshold, such as thirty. Additionally, the first photograph 442 may be displayed before the second photograph 444 in response to the respective tag count of the first photograph 442 being greater than the second photograph 444. As a specific example, the first photograph 442 may have a greater tag_count_pos than the second photograph 444. In specific examples, multiple thresholds may be used. For example, the first and second photographs 442, 444 are prioritized in response to the tag_count_pos being above thirty and the tag_count_self being above ten. The example counts and threshold(s) are provided for illustrative purposes and not intended to limit any example in accordance with the present disclosure.

Various terminology as used in the Specification (including claims) connote a plain meaning in the art unless otherwise indicated. As examples, the Specification describes and/or illustrates aspects useful for implementing the claimed disclosure by way of various circuits or circuitry which may be illustrated as or using terms such as blocks, modules, device, system, unit, controller, and/or other circuit-type depictions. For instance, reference numerals 232, 234 and 320 of FIGS. 2-3 depict a block/module as described herein. Such circuits or circuitry are used together with other elements to exemplify how certain examples may be carried out in the form or structures, functions, operations, activities, etc. For example, in certain of the above-discussed examples, various modules are discrete logic circuits or programmable logic circuits for implementing these operations/activities, as may be carried out in the approaches shown in FIG. 1. In certain examples, such a programmable circuit may include memory circuitry for storing and accessing a program to be executed as a set (or sets) of instructions. Additionally and/or alternatively, the program may be used as configuration data to define how the programmable circuit is to perform, and computer-readable instructions, configuration data, and/or process as described and shown in FIG. 3 is used by the programmable circuit to perform the related, functions, operations, activities, etc. Depending on the application, the instructions, configuration data, and/or process may be implemented in logic circuitry, with the instructions, whether characterized in the form of object code, firmware or other type of computer readable instructions) stored in and accessible from a memory (circuit).

Based upon the above discussion and illustrations, the various modifications and changes may be made to the various examples without strictly following the examples and applications illustrated and described herein. For example, methods as depicted in the Figures may involve elements carried out in various orders, with various aspects of the examples herein retained, or may involve fewer or more elements. For instance, the method 100 illustrated by FIG. 1 may be implemented in the environment 230 illustrated by FIG. 2 and/or via the computing device illustrated by FIG. 3. As another example, each of the audio/visual devices 240 illustrated by FIG. 2 may include the computing device illustrated by FIG. 3. Such modifications do not depart from the true scope of various aspects of the disclosure, including aspects set forth in the claims.

What is claimed is:

1. A method comprising:
in response to disseminated audio/visual content, monitoring reactions of a plurality of users to the audio/visual content using reaction-specific data received via communication circuitry from audio/visual user devices; and
categorizing the reactions as corresponding to one of a plurality of reaction contexts to tag the audio/visual content with the corresponding reaction context.

2. The method of claim 1, wherein the plurality of reaction contexts include a positive reaction, a negative reaction, and a neutral reaction, the method further including tagging the audio/visual content by associating text indicative of the corresponding reaction context with the audio/visual content.

3. The method of claim 1, further including:
disseminating the audio/visual content over a communication network for accessibility by the plurality of users; and
increasing a tag count associated with the corresponding reaction context for the audio/visual content.

4. The method of claim 1, wherein monitoring reactions by the plurality of users includes extracting facial features from camera input for one of the plurality of users, and categorizing the particular reaction of the user using the extracted facial features.

5. The method of claim 1, wherein monitoring reactions by the plurality of users includes extracting speech features from microphone input for one of the plurality of users, and categorizing the particular reaction of the user using the extracted speech features.

6. The method of claim 1, wherein the plurality of reaction contexts include emotions, and the method further including disseminating a plurality of audio/visual content, including the audio/visual content by:
graphically displaying the plurality of audio/visual content, including the audio/visual content, as accessible on a social network; and
changing the graphical display associated with the audio/visual content based on the categorization of the one of the plurality of reaction contexts.

7. The method of claim 1, wherein the method further including increasing a tag count for each of the plurality of reaction contexts, and graphically displaying the tag counts as being associated with the audio/visual content.

8. A non-transitory computer-readable medium storing a set of instructions executable by a processor circuit to cause a computing device to:
capture a reaction of a user to audio/visual content using data from an audio/visual user device;
communicate reaction-specific data associated with the reaction to categorize the reaction as corresponding to one of a plurality of reaction contexts and to tag the audio/visual content; and
change a graphical display associated with the audio/visual content based on tag data indicative of a tag count of monitored reactions of a plurality of users, including the user, to the audio/visual content.

9. The non-transitory computer-readable medium of claim 8, wherein the reaction-specific data includes indication of the categorization and tag of the audio/visual content, and the instructions are executable to change the graphical display with respect to other audio/visual content as categorized for the one of the plurality of reaction contexts.

10. The non-transitory computer-readable medium of claim 8, wherein the instructions are executable to prioritize the graphical display of the audio/visual content over a plurality of other audio/visual content responsive to the tag count being above a threshold.

11. The non-transitory computer-readable medium of claim 8, wherein the instructions are executable to extract reaction features from the data from the audio/visual user device, compare the reaction features to stored features, and increase the tag count in response to the comparison.

12. An apparatus comprising:
a first circuit to receive reaction-specific data associated with a plurality of reactions to an audio/visual content by a plurality of users, the reaction-specific data respectively received from a plurality of audio/visual user devices; and
a second circuit to:
categorize each of the plurality of reactions as corresponding to one of a plurality of reaction contexts using the reaction-specific data, the plurality of reaction contexts including a positive reaction, a negative reaction, and a neutral reaction; and
in response to the corresponding reaction contexts, tag the audio/visual content and increase a tag count associated with the plurality of reactions contexts for the audio/visual content.

13. The apparatus of claim 12, wherein the second circuit is to identify reactions are associated with unique users of the plurality of users based on the reaction-specific data communicated by the plurality of audio/visual user devices and to increase the tag count using the reaction contexts associated with the unique users.

14. The apparatus of claim 12, wherein the first circuit and the second circuit are integrated together in a computer system to communicate with the plurality of audio/visual user devices, each of the plurality of audio/visual user devices having a communication circuit and a processor circuit, and the audio/visual content is selected from: a video, a photograph, an audio file, an article, and a trademark.

15. The apparatus of claim 12, wherein the first circuit is integrated in a computer system to communicate with the plurality of audio/visual user devices, and the second circuit is to identify one of the plurality of reactions is a disparagement reaction, and, in response, to disregard the respective reaction context associated with the reaction for the tag count.
